(19) United States
(12) Patent Application Publication
(10) Pub. No.: US 2007/0078250 A1
(43) Pub. Date: Apr. 5, 2007

(54) Liquid organopolysiloxanes

(75) Inventor: Hartmut Ackermann, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/528,210

(22) Filed: Sep. 27, 2006

(30) Foreign Application Priority Data
Oct. 4, 2005 (DE) 10 2005 047 396.2

(51) Int. Cl. C08G 77/04

(52) U.S. Cl. 528/10

(57) ABSTRACT

Liquid organopolysiloxanes comprising units of the general formula
RₐX_{b}SiO_{(4-a-b)/2} (I), where R is a hydrocarbon group, X is halogen or an alkoxy group, and b is 0-3, with the proviso that the sum a +b is ≦3, a is 1 in at least 50% of the units of the organopolysiloxane and the organopolysiloxanes are liquid at 20° C. and a pressure of from 900 to 1100 hPa.

### BACKGROUND OF THE INVENTION

1. Field of the Invention

The invention relates to liquid, highly branched or resinous organopolysiloxanes, processes for the preparation thereof and to the use thereof.

2. Background Art

Silicone resins are generally solid or highly viscous at room temperature, which therefore does not permit direct application for many end uses.

DE 195 17 346 A describes a siloxane emulsion as an application form. A disadvantage is the presence, in many cases, of a not inconsiderable amount of emulsifier, which is not desired and is intolerable in many applications. Thus, for example, loss of adhesion may occur in the case of coatings. In applications to plastics, desired performance characteristics such as hydrophobicity are adversely affected, and in some cases even eliminated, by the emulsifiers. Instabilities of emulsions in general are also disadvantageous. Furthermore, water may not be suitable as a dispersed phase, for example with corrosion-sensitive substrates.

DE 41 28 893 A describes a dispersion and a solution as application forms in addition to an emulsion. A disadvantage of dispersions is the non-reproducible adjustment of the dispersion and the settling behavior thereof. Solutions generally have no disadvantages with regard to instability of the application form. The use of organic solvents has the advantage of good dilutability in combination with good handling properties. However, the choice of the solvent is greatly limited by relevant environmental and toxicological requirements. Furthermore, organic solvents are substances which are foreign to silicones and which may adversely affect compatibility.

### SUMMARY OF THE INVENTION

The invention is directed to organopolysiloxane resins which are liquid. The liquid organopolysiloxane resins generally exhibit low-VOC emissions and good storage stability.

### DETAILED DESCRIPTION OF THE PREFERRED EMBODIMENT(S)

In the context of the present invention, the term organopolysiloxanes is intended to include, polymeric, oligomeric and dimeric siloxanes, more specifically, to organopolysiloxanes comprising units of the general formula
RₐX_{b}SiO_{(4-a-b)/2} (I),
in which
R are identical or different and are monovalent, SiC-bonded, optionally substituted hydrocarbon radicals,
X are identical or different and are a halogen atom or a radical —OR¹ where R¹ is a hydrogen atom or an optionally substituted hydrocarbon radical,
a is 0, 1, 2 or 3 and
b is 0, 1, 2 or 3,
   with the proviso that the sum a +b is ≦3, a is equal to 1 in at least 50% of the units of the organopolysiloxane, and the organopolysiloxanes are liquid at 20° C. and at a pressure of from 900 to 100 hPa.

Examples of radical R are alkyl radicals such as the methyl, ethyl, n-propyl, isopropyl, n-butyl, isobutyl, tert-butyl, n-pentyl, isopentyl, neopentyl or tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical; alkenyl radicals such as the vinyl and the allyl radicals; cycloalkyl radicals such as cyclopentyl, cyclohexyl, cycloheptyl and methylcyclohexyl radicals; aryl radicals such as the phenyl and the naphthyl radical; alkaryl radicals such as o-, m-, p-tolyl radicals, xylyl radicals and ethylphenyl radicals; aralkyl radicals such as the benzyl radical and the α- and the β-phenylethyl radicals.

Examples of substituted radicals R are all radicals mentioned above for R, preferably substituted by mercapto groups, epoxy-functional groups, carboxyl groups, keto groups, enamine groups, amino groups, aminoethylamino groups, isocyanato groups, aryloxy groups, acryloyloxy groups, methacryloyloxy groups, hydroxyl groups and halogen groups.

Radical R preferably includes hydrocarbon radicals having 1 to 18 carbon atoms, most preferably hydrocarbon radicals having 1 to 12 carbon atoms, in particular the methyl, the phenyl and the isooctyl radicals.

Examples of R¹ include the examples stated for radical R. Radical R¹ preferably includes hydrocarbon radicals having 1 to 6 carbon atoms, most preferably hydrocarbon radicals having 1 to 3 carbon atoms, and in particular methoxy and ethoxy radicals.

Examples of radical X are halogen atoms such as chlorine, bromine and fluorine, and the hydroxyl, methoxy, ethoxy, n-propoxy, isopropoxy, 1-n-butoxy, 2-n-butoxy, isobutoxy, tert-butoxy, n-pentyloxy, isopentyloxy, neopentyloxy, tert-pentyloxy and n-hexyloxy radicals. Radical X preferably are radicals —OR¹, more preferably the radicals —OH, OCH₃ and —OCH₂CH₃. If radical X is a halogen atom, the chlorine atom is preferred.

The variable a preferably is 1, 2 or 3, more preferably 1; while b preferably is 0, 1 or 2. Preferably at least 60% of all units of the formula (I) are those having b equal to 0, more preferably at least 70%, and preferably, a is equal to 1 in at least 55% of all units of the formula (I).

The inventive organopolysiloxane resins are most preferably those in which a is equal to 1 in at least 60% of all units of the formula (I) and a is 2 or 3 in not more than 30% of all units of the formula (I). In particular, the organopolysiloxane resins according to the invention are those in which a is 1 in at least 65% of all units of the formula (I) and a is 2 or 3 in not more than 25% of all units of the formula (I).

The organopolysiloxanes according to the invention are preferably those of the formula
[RSiO_{3/2}]_{g}[R₂SiO]ₕ[R₃SiO_{1/2}]_{c}[SiO_{4/2}]_{d}[R¹O_{1/2}]ₑ[HO_{1/2}]_{f}
where R is a methyl radical or isooctyl radical, R¹ is a methyl, ethyl or butyl radical and g=2-200, h=0-100, c=0-50, d=0-100, e=0-20, and f=0-10.

Further examples of the organopolysiloxane resins according to the invention are resins of the type:
[OctSiO_{3/2}]_{0.07}[ProSiO_{3/2}]_{0.73}[OctSi(OR²)O_{2/2}]_{0.02}[ProSi(OR²)O_{2/2}]_{0.17}[OctSi(OR²)₂O_{1/2}]_{0.00}[ProSi(OR²)₂O_{1/2}]_{0.01},
[NonSiO_{3/2}]_{0.40}[ProSiO_{3/2}]_{0.13}[NonSi(OR²)O_{2/2}]_{0.30}[ProSi(OR²)O_{2/2}]_{0.10}[NonSi(OR²)₂O_{1/2}]_{0.04}[ProSi(OR²)₂O_{1/2]}_{0.03},
[DodecSiO_{3/2}]_{0.16}[ProSiO_{3/2}]_{0.25}[DodecSi(OR²)O_{2/2}]_{0.23}, [ProSi(OR²)O_{2/2}]_{0.34}[DodecSi(OR²)₂O_{1/2}]_{0.01}[ProSi(OR²)₂O_{1/2}]_{0.01},
[IoSiO3/2]0.40[EtSiO3/2]0.14[IoSi(OR²)O_{2/2}]_{0.29}[EtSi(OR²)O_{2/2}]_{0.13}[IoSi(OR²)₂O_{1/2}]_{0.03}[EtSi(OR²)₂O_{1/2}]_{0.01} and
[IoSiO_{3/2}]_{0.16}[MeSiO_{3/2}]_{0.25}[IoSi(OR²)O_{2/2}]_{0.23}[MeSi(OR²)O_{2/2}]_{0.34}[IoSi(OR²)₂O_{1/2}]_{0.01}[MeSi(OR²)₂O_{1/2}]_{0.01} and
[MeSiO_{3/2}]_{13.5}[IoSiO_{3/2}]_{2.1}[Me₂SiO]_{3.3}[Me₃SiO_{1/2}]_{1.6}[MeO_{1/2}]_{1.3}[HO_{1/2}]_{0.2},
[MeSiO_{3/2}]_{20.4}[Me₂SiO]_{2.8}[Me₃SiO_{1/2}]_{2.1}[EtO_{1/2}]_{1.5}[HO_{1/2}]_{0.6} and
[MeSiO_{3/2}]_{15.3}[Me₂SiO]_{2.8}[Me₃SiO_{1/2}]_{1.3}[EtO_{1/2}]_{1.5}[HO_{1/2}]_{1.0}, where
   Me is a methyl radical, Et is an ethyl radical, Pro is a propyl radical, Oct is an n-octyl radical, Io is an isooctyl radical, Non is a nonyl radical, Dodec is an n-dodecyl radical, and R² is a hydrogen atom or ethyl radical. The organopolysiloxanes preferably have a viscosity of from 1 to 500,000 mm²/s, more preferably from 1 to 50,000 mm²/s, at 25° C., and can be prepared by the processes known per se in silicone chemistry, such as, for example, by hydrolysis and condensation reactions of halosilanes or alkoxy silanes.

The organopolysiloxanes are preferably prepared by partly alkoxylating or hydrolyzing or condensing chlorosilanes with aqueous alcohols in a first step and, in a second step, hydrolyzing or condensing the reaction mixture, optionally in the presence of a water-insoluble organic solvent, by addition of from 0.3 to 10 mol of water per one mole of silicon component.

Alternatively, the organopolysiloxanes can however, also be prepared by metering or initially introducing alkoxysilanes into an aqueous medium, said alkoxysilanes undergoing hydrolysis and then condensation after addition of a suitable catalyst with liberation of alcohols. Optionally, the organopolysiloxanes thus produced can be subjected to an alkaline aftertreatment. Methoxy- or ethoxysilanes are most preferably used for the hydrolysis.

The organopolysiloxanes can be used for all purposes for which organopolysiloxanes have also been used to date, such as, for example, protection of structures, in the coating sector, in cosmetic products and in the textile and paper sectors. They are particularly suitable for the preparation of emulsions and as binders for the preparation of paints and finishes.

The organopolysiloxanes according to the invention have the advantage that they are liquid, low-VOC and storage-stable under ambient conditions. Moreover, the organopolysiloxanes are soluble in organic solvents and chemically reactive. Furthermore, they have the advantage of a high degree of crosslinking and can be emulsified, preferably without dilution, and furthermore, are clear and colorless liquids. Last, but not least, the inventive organopolysiloxanes have the advantage that they are outstandingly suitable for use in silicone resin paints.

In the following examples, all data relating to parts and percentages are based on weight, and examples are carried out at ambient pressure, i.e. at about 1000 hPa, and at room temperature, i.e. about 20° C. or a temperature which results on combining the reactants at room temperature without additional heating or cooling, unless stated otherwise. All viscosity data mentioned in the examples are intended to be based on a temperature of 25° C.

The average empirical formulae mentioned below arise from the evaluation of the ¹H—, and ²⁹Si—NMR and GPC spectroscopy, (measured against polystyrene standard, taking into account the weight average Mw) of the respective product.

### EXAMPLE 1

207.8 g of a chlorosilane mixture comprising 187 g of methyltrichlorosilane and 20.8 g of dimethyldichlorosilane are initially introduced into a three-necked flask having a stirrer, reflux condenser and dropping funnel, and 166.2 g of a mixture of 149.6 g of ethanol and 16.6 g of water are metered in with stirring in the course of 10 minutes. For hydrolysis/condensation, 14.03 g of trimethylchlorosilane and 334.84 g of toluene are added to 284.6 g of the hydrogen chloride concentrated reaction mixture thus obtained, and 56.92 g of water are metered in with thorough mixing in the course of 35 minutes.

By adding 341.5 g of water, the acid concentration is reduced to an unreactive level so that, after careful thorough mixing and allowing to stand subsequently for 30 minutes, the toluene resin phase can be separated from the aqueous/ethanolic hydrogen chloride phase without further condensation steps taking place. In further operations, the toluene resin phase is neutralized with sodium bicarbonate, freed from catalytically active metal traces with active carbon and then filtered over filter aids and freed from volatile constituents in a rotary evaporator at 120-200° C. and a vacuum of 30 mbar, it being possible to recycle ethanol and toluene to the preparation process after redistillation.

87.8 g of a siloxane having the average empirical formula [MeSiO_{3/2}]_{20.4}[Me₂SiO]_{2.8}[Me₃SiO_{1/2}]_{2.1}[EtO_{1/2}]_{1.5}[HO_{1/2}]_{0.6} are obtained as a clear and colorless liquid having a viscosity of 11,500 mPa·s, Me being a methyl radical and Et being an ethyl radical.

### EXAMPLE 2

340 g of a chlorosilane mixture comprising 278.8 g of methyltrichlorosilane, 34 g of dimethyldichlorosilane and 27.2 g of isooctyltrichlorosilane are initially introduced into a three-necked flask having a stirrer, reflux condenser and dropping funnel, and 374 g of a mixture of 344 g of ethanol and 30 g of water are metered in with thorough mixing in the course of 10 minutes. For hydrolysis/condensation, 13.9 g of trimethylchlorosilane and 1200 g of toluene are added to 599 g of the hydrogen chloride concentrated reaction mixture thus obtained, and 120 g of water are metered in with thorough mixing in the course of 35 minutes.

By adding 720 g of water, the acid concentration is reduced to an unreactive level so that, after careful thorough mixing and allowing to stand subsequently for 30 minutes, the toluene resin phase can be separated from the aqueous/ethanolic hydrogen chloride phase without further condensation steps taking place. In further operations, the toluene resin phase is neutralized with sodium bicarbonate, freed from catalytically active metal traces with active carbon and then filtered over filter aids and freed from volatile constituents in a rotary evaporator at 120-200° C. and a vacuum of 30 mbar, it being possible to recycle ethanol and toluene to the process.
[MeSiO_{3/2}]_{15.2}[Me₂SiO]_{2.6}[Me₃SiO_{1/2}]_{0.9}[IoSiO_{3/2}]_{0.8}[EtO_{1/2}]_{2.0}[HO_{1/2}]_{0.3} are obtained as a clear and colorless liquid having a viscosity of 2501 mPa·s, Me being a methyl radical, 10 being an isooctyl radical and Et being an ethyl radical.

### EXAMPLE 3

A mixture of 1.2 l/h of methyltrichlorosilane, 0.16 l/h of dimethyldichlorosilane and 0.17 l/h of trimethyltrichlorosilane and a mixture of 1.54 l/h of ethanol and 0.08 l/h of water are metered continuously into a loop reactor having an internal volume of 2 l and a natural circulation, a reaction temperature of from 30 to 34° C. and an average residence time of 48 minutes being established. 2.42 l/h of the partial alkoxylated/partial hydrolysis product thus prepared are transferred continuously at a delivery rate of 1 m³/h into a second loop reactor having an internal volume of 6 l, on the intake side before the centrifugal pump. Furthermore, 3.2 l/h of toluene and 0.47 l/h of water are metered continuously on the intake side before the centrifugal pump (residence time: 70 minutes, temperature in the hydrolysis/condensation loop: 40° C.).

6.1 l/h of the hydrolysis product/condensate are transported continuously from the second reaction loop. 2.85 l/h of water are metered into this pipe, the mixture being thoroughly mixed by means of a static mixer.

9 l/h of the reaction mixture are metered continuously into a phase separation container having an internal volume of 12 l, and the upper phase is separated from the lower phase. The further working-up is effected as described in examples 1 and 2. Ethanol and toluene can be recycled to the process after redistillation. 0.85 l/h of a siloxane of the empirical formula [MeSiO_{3/2}]_{15.3}[Me₂SiO]_{2.8}[Me₃SiO_{1/2}]_{1.3}[EtO_{1/2}]_{1.5}[HO_{1/2}]_{1.0} is obtained as a colorless liquid having a viscosity of 2500 cst.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An organopolysiloxane comprising units of the general formula
RₐX_{b}SiO_{(4-a-b)/2} (I),
in which
R¹ each is identical or different and is monovalent, SiC-bonded, optionally substituted hydrocarbon radical,
X each is an identical or different halogen atom or a radical —OR¹ where R¹ is a hydrogen atom or an optionally substituted hydrocarbon radical,
a is 0, 1, 2 or 3 and
b is 0, 1, 2 or 3,
with the proviso that the sum a+b is ≦3, a is equal to 1 in at least 50% of the units of the organopolysiloxane, and the organopolysiloxanes are liquid at 20° C. and a pressure of from 900 to 1100 hPa.

2. The organopolysiloxane of claim 1, wherein radical X is a radical —OR¹.

3. The organopolysiloxane of claim 1, wherein a is 1 in at least 60% of all units of the formula (I) and a is 2 or 3 in not more than 30% of all units of the formula (I).

4. The organopolysiloxane of claim 1, wherein a is 1 in at least 65% of all units of the formula (I) and a is 2 or 3 in not more than 25% of all units of the formula (I).

5. The organopolysiloxane of claim 1, wherein at least 60% of all units of the formula (I) are those in which b is 0.

6. The organopolysiloxane of claim 1, wherein the organopolysiloxane viscosity is from 1 to 500,000 mm²/s at 25° C.

7. The organopolysiloxane of claim 1, wherein the viscosity is from 1 to 50,000 mm²/s at 25° C.
